(19) United States
(12) Patent Application Publication
(10) Pub. No.: US 2025/0330818 A1
(43) Pub. Date: Oct. 23, 2025

(54) METHOD FOR SECURITY CONTROL BASED ON RELATIVE LOCATION OF DEVICE, APPARATUS FOR THE SAME, COMPUTER PROGRAM FOR THE SAME, AND RECORDING MEDIUM STORING COMPUTER PROGRAM

(71) Applicant: Fasoo Co., Ltd, Seoul (KR)

(72) Inventor: Hyungdong YOON, Seoul (KR)

(21) Appl. No.: 19/186,609

(22) Filed: Apr. 22, 2025

(30) Foreign Application Priority Data
Apr. 23, 2024 (KR) 10-2024-0054234

(51) Int. Cl. H04W 12/63; H04W 12/67

(52) U.S. Cl. CPC H04W 12/63; H04W 12/67

(57) ABSTRACT

A method, a device and a computer program for controlling security of a device based on a relative location of a device and a recording medium thereof are described. A method for security control based on a relative location of a first device may include detecting at least one second device; based on at least one of a device type or the number of device detections of the at least one second device, determining a security level of the first device; and allowing or restricting a specific operation of the first device based on the security level. The device type may include at least one of a necessary location reference device or a related location reference device.

### CROSS-REFERENCE TO RELATED APPLICATIONS

The present application claims priority to Korean Patent Application No. 10-2024-0054234 filed on Apr. 23, 2024, the contents of which are hereby incorporated by reference in its entirety.

### TECHNICAL FIELD

The present disclosure relates to security control, and more particularly, relates to a method, a device and a computer program for controlling the security of a device based on the relative location of a device and a recording medium thereof.

### BACKGROUND ART

The location of a movable device such as a laptop, a smart phone, a tablet PC, etc. may be changed depending on a user. In the existing location-based operation, the location of a movable device is generally determined based on a device whose location is fixed, and an appropriate service may be provided to a corresponding device based on the location of a movable device determined in this manner. For example, in the existing location-based operation, the approach of a user or a movable device in a fixed device may be detected to determine that a corresponding user or movable device is located around a fixed device. For example, when a customer approaches a fixed device in a specific store among the fixed devices pre-installed per store in a large shopping mall, guidance information about a corresponding store may be provided to a customer's device.

It is difficult to apply this existing location-based service to location-based security

control as it is. For example, location-based security control may be considered that grants a function or an authority (e.g., allows access to assets, applications, networks, etc.) only when a user is in a secure location. If a user's location is determined based on one fixed device, the location of an actual user and the location of a user detected by a location-based security system may be different when the location or information of a fixed device is arbitrarily changed, which may lead to a security threat. Alternatively, even in a region where a fixed device does not exist or in a region where the location of a user may not be detected, it may also be necessary to grant a function or an authority if a corresponding user is in a secure location. However, for the existing location-based operation, a method for solving this problem has not been prepared yet.

### DISCLOSURE

### Technical Problem

A technical problem of the present disclosure is to provide a method and a device for controlling the security of a device based on the relative location of a device.

An additional technical problem of the present disclosure is to provide a method and a device for applying security control to a device based on the type and relative location of multiple devices.

The technical objects to be achieved by the present disclosure are not limited to the technical matters mentioned above, and other technical objects not mentioned are to be clearly understood by those skilled in the art from the following description.

### Technical Solution

A method for security control based on a relative location of a first device according to an aspect of the present disclosure may include detecting at least one second device; based on at least one of a device type or the number of device detections of the at least one second device, determining a security level of the first device; and allowing or restricting a specific operation of the first device based on the security level. The device type may include at least one of a necessary location reference device or a related location reference device.

A method for supporting security control based on a relative location of a device by a server according to an additional aspect of the present disclosure may include obtaining information about a device type of each of at least one device; defining a plurality of security levels corresponding to at least one of the device type or the number of device detections, wherein a specific operation of each device is allowed or restricted based on each security level; and providing a user-specific policy including the plurality of security levels to a device corresponding to the user. The device type may include at least one of a necessary location reference device or a related location reference device.

It is to be understood that the foregoing summarized features are exemplary aspects of the following detailed description of the present disclosure and are not intended to limit the scope of the present disclosure.

### Technical Effects

According to the present disclosure, a method and a device for controlling the security of a device based on the relative location of a device may be provided.

According to the present disclosure, a method and a device for applying security control to a device based on the type and relative location of multiple devices may be provided.

The advantageous effects of the present disclosure are not limited to the foregoing descriptions, and additional effects will become apparent to those having ordinary skill in the pertinent art to the present disclosure based upon the following descriptions.

### DESCRIPTION OF DIAGRAMS

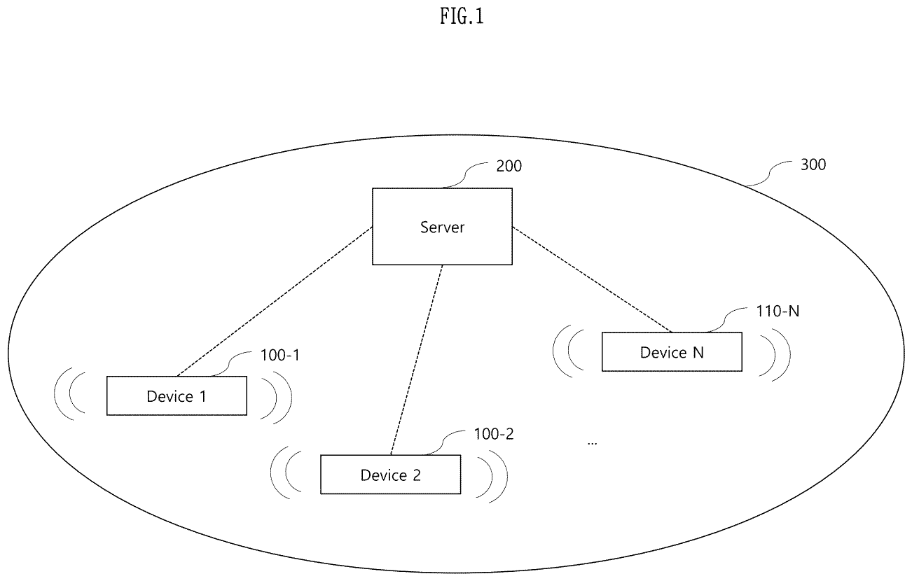

FIG. 1 is a drawing showing an example of a security system according to the present disclosure.

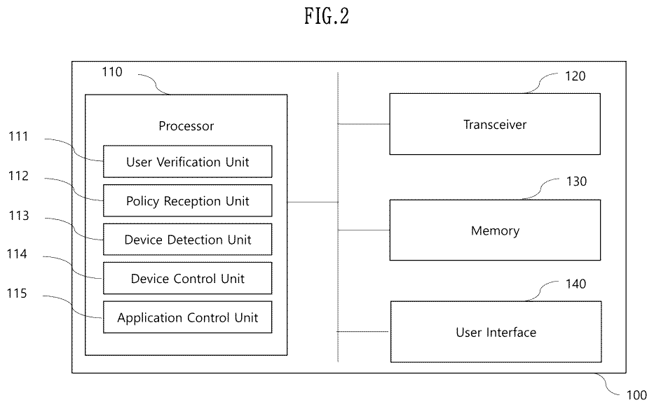

FIG. 2 is a drawing showing an illustrative configuration of a device according to the present disclosure.

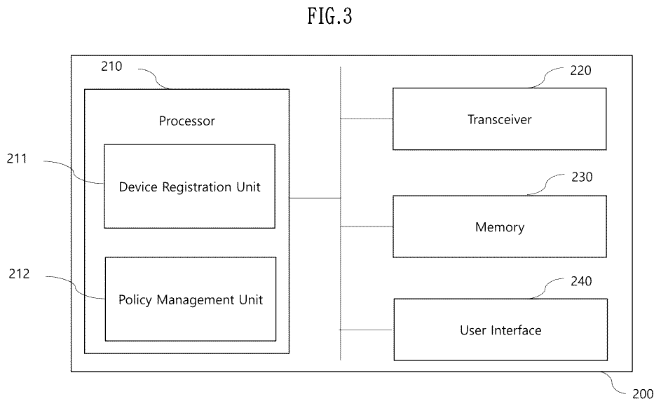

FIG. 3 is a drawing showing an illustrative configuration of a server according to the present disclosure.

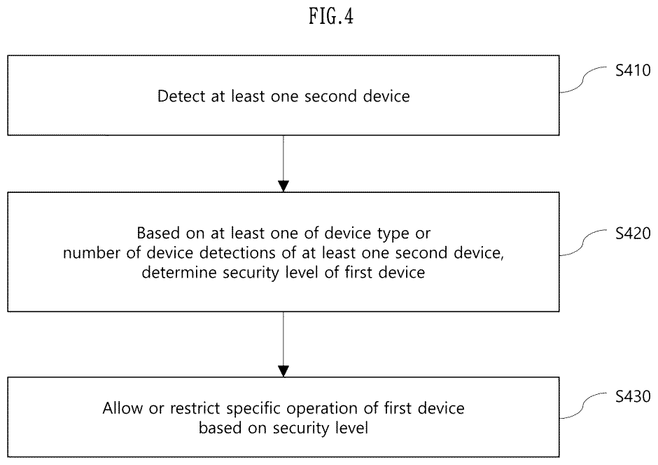

FIG. 4 is a drawing for describing an example of a device operation according to the present disclosure.

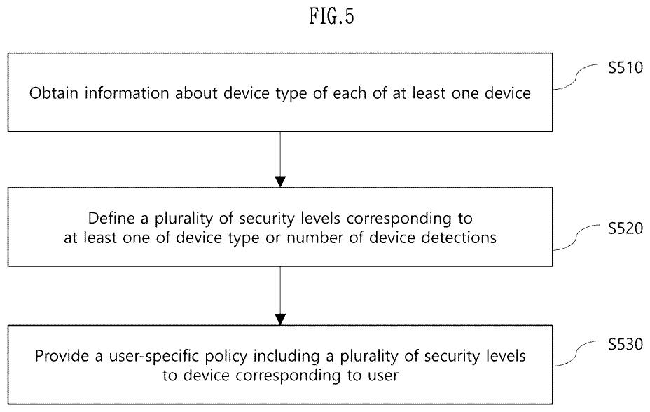

FIG. 5 is a drawing for describing an example of a server operation according to the present disclosure.

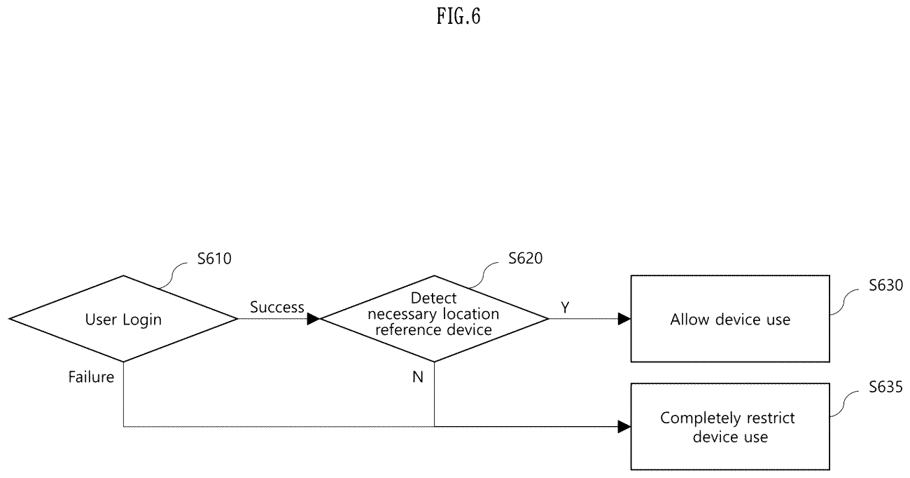

FIG. 6 is a drawing for describing an example of secondary authentication according to the present disclosure.

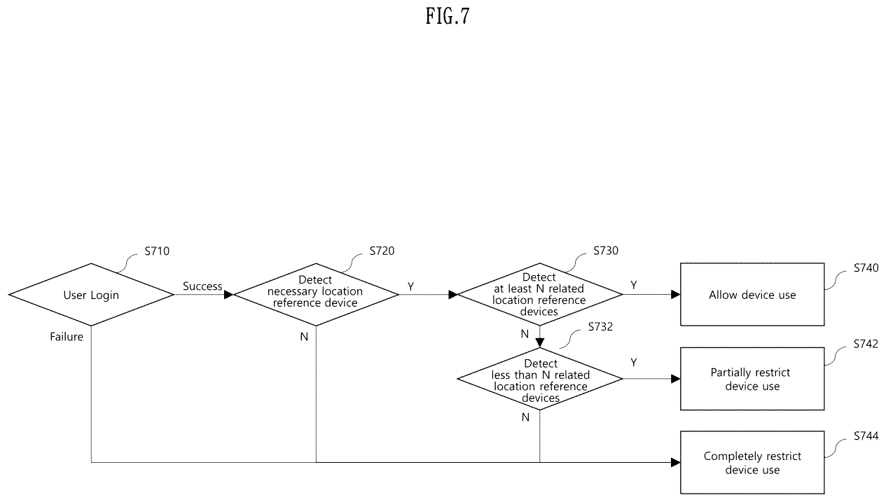

FIG. 7 is a drawing for describing another example of secondary authentication according to the present disclosure.

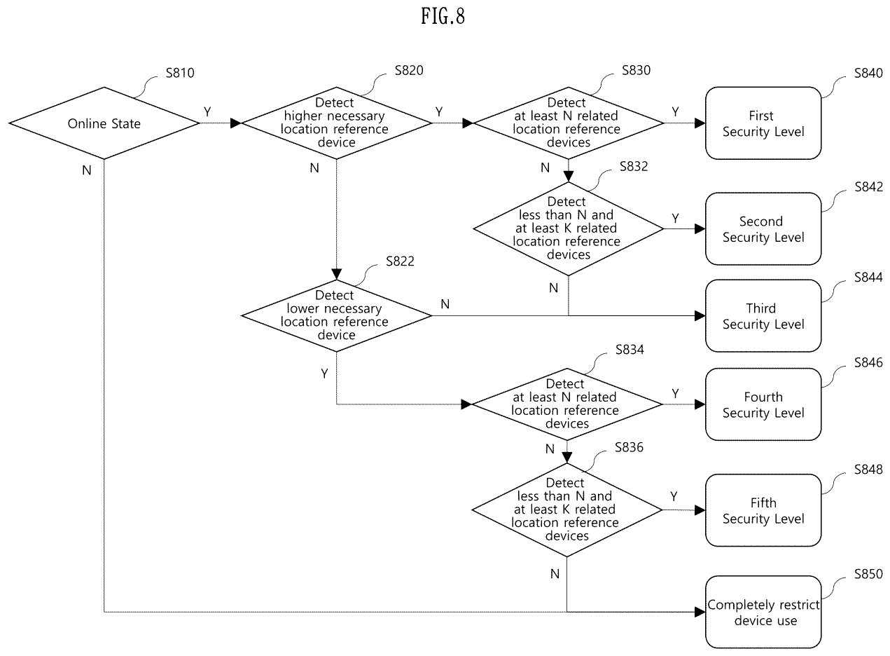

FIG. 8 is a drawing showing an example of a security control operation in an online state according to the present disclosure.

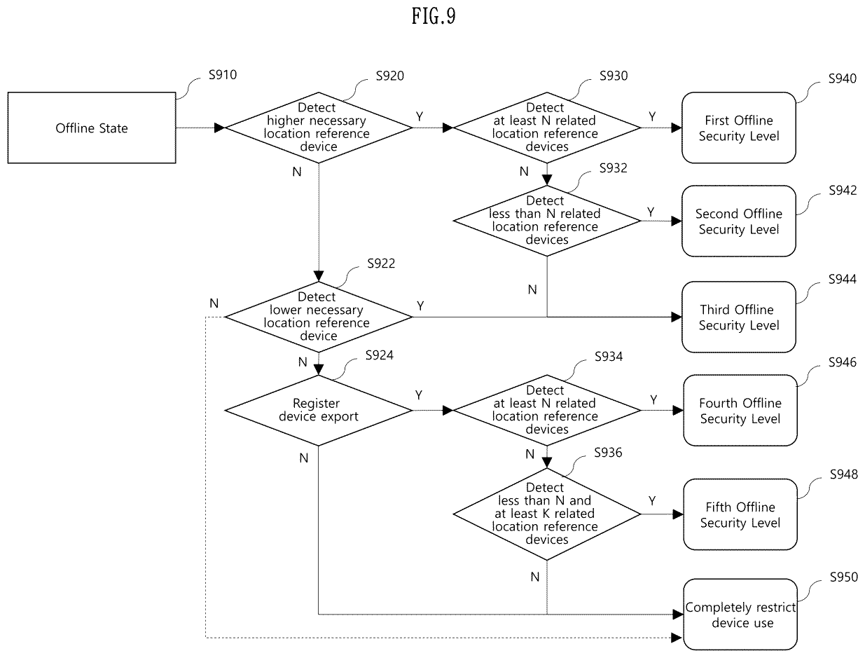

FIG. 9 is a drawing showing an example of a security control operation in an offline state according to the present disclosure.

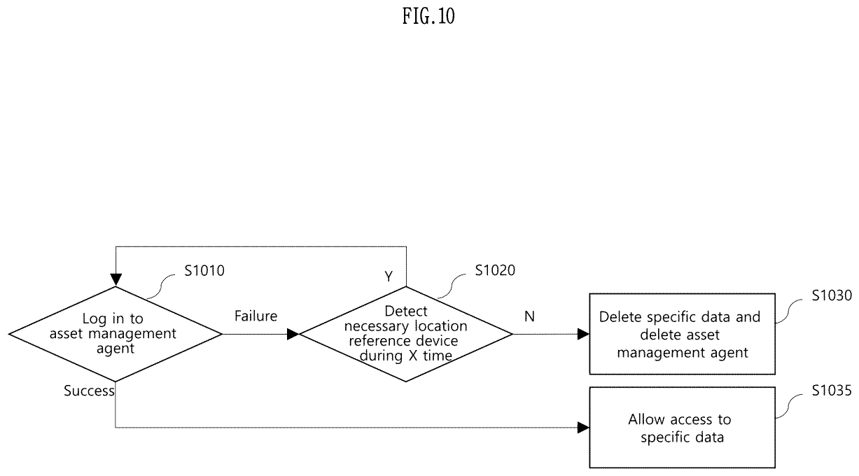

FIG. 10 is a drawing for describing an example in which an asset management solution

is applied together with a relative location-based security control method according to the present disclosure.

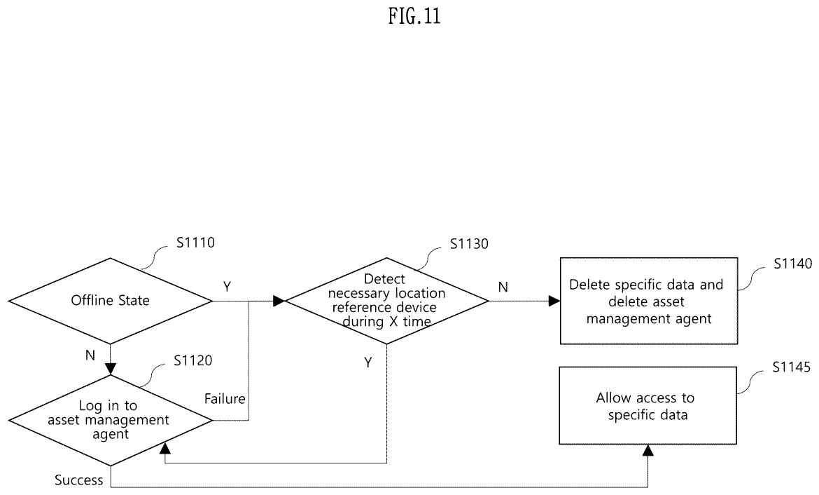

FIG. 11 is a drawing for describing another example in which an asset management solution is applied together with a relative location-based security control method according to the present disclosure.

### DETAILED DESCRIPTION

Hereinafter, embodiments of the present invention will be described in detail so that those skilled in the art can easily carry out the present invention referring to the accompanying drawings. However, the present disclosure may be embodied in many different forms and is not limited to the embodiments described herein.

In the following description of the embodiments of the present invention, a detailed description of known functions and configurations incorporated herein will be omitted when it may make the subject matter of the present disclosure unclear. Parts not related to the description of the present disclosure in the drawings are omitted, and similar parts are denoted by similar reference numerals.

In the present disclosure, when an element is referred to as being “connected”, “coupled”, or “accessed” to another element, it is understood to include not only a direct connection relationship but also an indirect connection relationship. Also, when an element is referred to as “containing” or “having” another element, it means not only excluding another element but also further including another element.

In the present disclosure, the terms “first”, “second”, and so on are used only for the purpose of distinguishing one element from another, and do not limit the order or importance of the elements unless specifically mentioned. Thus, within the scope of this disclosure, the first component in one embodiment may be referred to as a second component in another embodiment, and similarly a second component in one embodiment may be referred to as a second component in another embodiment.

In the present disclosure, components that are distinguished from one another are intended to clearly illustrate each feature and do not necessarily mean that components are separate. That is, a plurality of components may be integrated into one hardware or software unit, or a single component may be distributed into a plurality of hardware or software units. Accordingly, such integrated or distributed embodiments are also included within the scope of the present disclosure, unless otherwise noted.

In the present disclosure, the components described in the various embodiments do not necessarily mean essential components, but some may be optional components. Accordingly, embodiments consisting of a subset of the components described in one embodiment are also included within the scope of this disclosure. Also, embodiments that include other components in addition to the components described in the various embodiments are also included in the scope of the present disclosure.

The definitions of the terms used in the present disclosure are as follows.

A location reference device is a device that transmits a wireless communication signal (i.e., a location reference signal) so that another device may determine its own location (i.e., a location relative to a location reference device). A first device may be a location reference device for a second device, and similarly, a second device may be a location reference device for a first device. In other words, a first device and a second device correspond to a location reference device for determining a location for each other.

A location reference device may be classified into a fixed location reference device and a mobile location reference device according to whether to change its location.

A fixed location reference device is a device that may transmit a location reference signal by being installed at a specific location. For example, a beacon installed on a building wall and transmitting a predetermined wireless communication signal, a fixed device including a function for transmitting a predetermined wireless communication signal (e.g., a printer including a function such as document scanning, copying, printing, etc. and a wireless communication function), the repeater of a predetermined wireless communication signal, etc. may correspond to a fixed location reference device. For example, a predetermined wireless communication signal may include at least one of a Bluetooth signal, a Wi-Fi signal or a Near Field Communication (NFC) signal. This short-range wireless communication signal is just an example, and the scope of the present disclosure may include examples in which other types of wireless communication signals are used as a location reference signal.

A mobile location reference device is a device that a location may be changed (e.g., carried by a user) and a location reference signal may be transmitted. For example, a user terminal, a smart phone, a laptop, a tablet PC, etc. including a function for transmitting a predetermined wireless communication signal may correspond to a mobile location reference device.

A location reference device may be classified into a necessary location reference device and a related location reference device according to the relevance with a security level described below.

A necessary location reference device corresponds to a location reference device that is basically required by a device performing security control to determine a security level. In other words, detection of a necessary location reference device may be related to the primary authentication procedure of security control. In the examples of the present disclosure, except for a special condition, when a device performing security control does not detect any necessary location reference device, the highest security level may be applied to a corresponding device (i.e., all security-related operations may be restricted). When a device performing security control detects even one necessary location reference device, a low security level may be applied to a corresponding device (i.e., some/all of the security-related operations may be allowed).

A related location reference device corresponds to a location reference device that is additionally required by a device performing security control to determine a security level. In other words, detection of a related location reference device may be related to the secondary authentication procedure of security control. In the examples of the present disclosure, except for a special condition, on the premise that a necessary location reference device is detected, a detailed security level may be determined according to the detection of a related location reference. For example, a plurality of related location reference devices are treated equally without distinction in determining a security level, and a detailed security level may be determined based on the number of related location reference device detections.

For example, most fixed location reference devices may correspond to a necessary location reference device, but some fixed location reference devices may correspond to a related location reference device according to a security level.

For example, a mobile location reference device may correspond to a necessary location reference device or may correspond to a related location reference device according to the security level of a user associated with a corresponding device. For example, a mobile device associated with/registered for an administrator such as an executive, a team leader, etc. in a company may correspond to a necessary location reference device and a mobile device associated with/registered for a general user of other positions may correspond to a related location reference device.

Hereinafter, a method for security control based on the relative location of a device according to the present disclosure will be described.

FIG. 1 is a drawing showing an example of a security system according to the present disclosure.

A security system providing the relative location-based security control service of a device according to the present disclosure may include multiple devices 100 where a corresponding service is performed and a server 200 supporting a corresponding service. In a security system, a device other than a server may also be referred to as a client.

A server 200 may perform a device and policy management function for defining a security level based on a device type and generating a user-specific policy including a security level to provide it to a device associated with a corresponding user.

For example, a server 200, based on the service region 300 of a security system where a relative location-based security control service is provided or applied, may obtain information on the device type of each of at least one device 100 within a corresponding service region. As described above, the device type of one device 100 may be a necessary location reference device or a related location reference device. The type of a different device 100 may be the same or different. For example, a server 200 may register and manage information of a fixed location reference device (e.g., a wireless communication signal beacon, a printer, etc.) within a service region 300. In addition, a server 200 may register and manage information of a mobile location reference device (e.g., a PC, a laptop, a mobile phone, etc.) mainly used within a service region 300 (i.e., for a general case excluding a case such as a business trip, an outside duty, etc.).

A server 200 may generate and manage a user-specific policy. For example, a user-specific policy may include at least one security level that allows or restricts a (security-related) operation on a device associated with each user. A low security level corresponds to few or no device operations being restricted (i.e., many device operations are allowed or all device operations are allowed), and a high security level corresponds to many or all device operations being restricted (i.e., few or no device operations are allowed). Each security level may correspond to the number of device detections and/or the type of a location reference device detected around for each user. In this way, a user-specific policy may be defined or registered in advance based on the number of device detections and the device type of a location reference device where mutual detection is required for each user (e.g., a necessary location reference device and/or a related location reference device).

Additionally or alternatively, a user-specific policy may be defined or configured in association with at least one of an online state (e.g., a state in which a device 100 is located within a service region 300 and connected to an internal network (or accessible to a security system)), an offline state (e.g., a state in which a device 100 is not located within a service region 300 or is not connected to an internal network even within a service region 300 (or inaccessible to a security system)) or whether it is allowed to take out a device (e.g., an offline state due to a business trip, an outside duty, etc.). In other words, for each of an online state, an offline state in which it is allowed to take out a device or an offline state in which it is not allowed to take out a device, a security level applied may be independently defined based on the type and/or number of devices detected around.

A device 100 may perform a function for verifying a user in order to apply a user-specific policy. User verification may include, for example, user authentication such as an ID and a password, biometric information, etc. A device 100 may store a user-specific policy provided from a server 200 in advance or if necessary, may search a user-specific policy stored in a server 200. A device 100 may interpret or parse a policy corresponding to a verified user to perform security control. For example, security control may include device control and/or application control.

A device 100 may perform a function for detecting a location reference device. For example, a user device that wants to perform security control may attempt to detect neighboring location reference device(s). For example, when a location reference device such as a neighboring wireless communication signal beacon or another user's PC/laptop/mobile phone, etc. is in operation, a user device may determine whether to detect a corresponding location reference device based on a wireless communication signal from each location reference device (e.g., by determining whether it is a signal of predetermined strength or higher, whether it is a signal including specific information or a specific pattern, etc.). For example, the detection of a neighboring location reference device may include wirelessly verifying an information list configured for each device.

A device 100 may perform device control and/or application control based on a location reference device detection result and a user-specific policy.

For example, device control may include comparing the information of a user logged into a device 100 with the identification information of a device 100 among the policies provided from a server 200, and if it is not a device associated with/registered for a corresponding user, blocking all operations of a corresponding user on a corresponding device. When logged-in user information corresponds to a user associated with/registered for a corresponding device 100, an appropriate security level defined in a policy may be applied by comparing a requirement for the type and/or number of devices included in a policy for a corresponding user with the type and/or number of neighboring location reference devices currently detected. For example, when a wireless communication signal beacon installed in an office (i.e., a necessary location reference device) is detected, a security level that allows booting and use of a corresponding device may be applied. Alternatively, when the device of at least two other users within the same group as a corresponding user (i.e., a related location reference devices) is detected and a printer device (i.e., a necessary location reference device) is detected, a security level that allows printing through a corresponding device may be applied. In this way, device control based on a user-specific policy may include control for various device functions such as network (e.g., internal wired or wireless network) connection, printing, scanning, user interface (e.g., a keyboard, a mouse, etc.), an external device access port (e.g., a USB port, etc.), power (e.g., forced termination), etc.

For example, application control may include controlling the execution/operation of at least one specific application and protecting/monitoring data/files generated by an application through linkage with a digital rights management (DRM)/data loss prevention (DLP) function according to a policy provided from a server 200. Application control may include comparing the information of a user logged into a device 100 with the identification information of a device 100, and if it is not a device associated with/registered for a corresponding user, blocking the access of a corresponding user to at least one specific application on a corresponding device. When logged-in user information corresponds to a user associated with/registered for a corresponding device 100, an appropriate security level defined in a policy may be applied by comparing a requirement for the type and/or number of devices included in a policy for a corresponding user with the type and/or number of neighboring location reference devices currently detected. For example, when a wireless communication signal beacon installed in an office (i.e., a necessary location reference device) is detected, a security level that allows the operation of a specific application may be applied. Alternatively, when the device of at least two other users within the same group as a corresponding user (i.e., a related location reference device) is detected, a security level that allows access to a specific asset (e.g., a shared file/folder) may be applied. Alternatively, for application control linked to DRM/DLP, a security level that blocks access to all protected assets associated with DRM/DLP may be applied when (at least one specific or all) location reference devices are not searched. In this way, application control based on a user-specific policy may include control for various application/asset access functions such as application execution, file access by extension, access by file format, monitoring/control by application function through linkage with a third-party solution (e.g., DRM/DLP), etc.

For example, when a user who wants to use a device is located in an office and a necessary location reference device at a fixed location(s) in a corresponding office (e.g., a wireless communication signal beacon) is detected, a user may use a corresponding device.

For example, when a user who wants to use a device is located in an office and there is no fixed necessary location reference device in a corresponding office, but necessary location reference devices of other neighboring users are detected, a user may use a corresponding device.

For example, when a user who wants to use a device is located in a place outside an office (e.g., a lobby) and a (fixed) necessary location reference device is detected at a corresponding place, a user may use a corresponding device. Alternatively, when a user who wants to use a device is located in a place outside an office (e.g., a lobby) and a necessary location reference device is not detected at a corresponding place, a user may use a corresponding device.

In this way, according to the present disclosure, a device including or accessible to an important asset (e.g., a user's work PC or smart phone, etc.) may be configured to operate only at a place/location that is determined to be safe in security. Furthermore, the security level of a place where a user device is located may be classified based on the type/number of neighboring devices (i.e., a location reference device) of a user device, and the operable range of a user device may be controlled according to the security level of a location/place.

The first device of a first user may be a necessary/related location reference device for the second device of a second user, and similarly, the second device of a second user may be a necessary/related location reference device for the second device of a first user.

As in examples described below, a location reference device may be classified into a necessary location reference device and a related location reference device to apply a variety of security levels, which may control a device/application operation. For example, based on whether a necessary location reference device is detected, whether at least N related location reference devices are detected, etc., various operations such as forced termination of a user device (power control), printing/scan control, etc. may be controlled. In addition, based on the type/number of detected location reference devices, it may be controlled to access a specific file/document/folder through a user device only at a location where specific location reference device(s) are detected.

FIG. 2 is a drawing showing an illustrative configuration of a device according to the present disclosure.

A device 100 may include a processor 110, a transceiver 120, a memory 130, and a user interface 140. The processor 110, the transceiver 120, the memory 130, and the user interface 140 may exchange data, requests, responses, commands, or the like through an internal communication network.

The processor 110 may control operations of the transceiver 120, the memory 130, and the user interface 140. The processor 110 may perform operations according to the present disclosure. In addition, the processor 110 may control the overall operation of the device 100 including components of the device 100 not shown in FIG. 2.

The transceiver 120 may perform a function of a physical layer that exchanges data with other entities through wired or wireless communication.

The memory 130 may store information generated or processed by the processor 110, software, operating system, application related to the operation of the device 100, or the like, and may include components such as a buffer. In addition, the memory 130 may store data, or the like according to the present disclosure. In addition, the memory 130 may include a storage (e.g., a hard disk, etc.) for temporarily storing or maintaining data.

The user interface 140 may detect operations, inputs, or the like of a user for the device 100 and transport it to the processor 110, or may output the processing result of the processor 110 in a way that the user may recognize.

The processor 110 of a first device according to an embodiment of the present disclosure may be configured to detect at least one second device, determine the security level of a first device based on at least one of the number of device detections or the device type of at least one second device, and allow or restrict the specific operation of a first device based on a security level.

A processor 110 according to an embodiment of the present disclosure may include functional units of a user verification unit 111, a policy reception unit 112, a device detection unit 113, a device control unit 114 and an application control unit 115. A user verification unit 111 may perform a user login/authentication-related function described by referring to FIG. 1. A policy reception unit 112 may receive and parse a user-specific policy provided from a server 200. A device detection unit 113 may determine whether to detect a corresponding device based on a wireless communication signal from a neighboring location reference device. A device control unit 114 may apply a security level to a device function based on a policy for a verified user and the type/number of detected devices. An application control unit 115 may apply a security level to an application function based on a policy for a verified user and the type/number of detected devices. The functional units of a processor 110 as above are just an example of the present disclosure, and may not necessarily include all functional units, and some functional units may be excluded or an additional functional unit may be included, and a plurality of functional units may be integrated or one functional unit may be configured by being separated into detailed functional units.

FIG. 3 is a drawing showing an illustrative configuration of a server according to the present disclosure.

A server 200 device may include a processor 210, a transceiver 220, a memory 230 and a user interface 240. A processor 210, a transceiver 220, a memory 230 and a user interface 240 may exchange data, a signal, a request, a response, a command, etc. through internal communication means.

A processor 210 may control the operation of a transceiver 220, a memory 230 and a user interface 240. A processor 210 may be configured to perform the operation of a server 200 device in document management and sharing under a document centralization environment according to the present disclosure.

A transceiver 220 may perform the function of a physical layer that exchanges data, a signal, etc. with other entities in a wired or wireless manner.

A memory 230 may store information generated or processed by a processor 210, software related to the operation of an organization target document management device 200 an operating system, an application, etc., and may also include a component such as a buffer, etc.

In addition, a memory 230 may include a folder structure according to the present disclosure and a storage (e.g., a hard disk, etc.) that stores or maintains data transmitted and received with a device 100.

A user interface 240 may detect a user's manipulation, input, etc. for a server 200 device and transmit it to a processor 210 or may output the processing result of a processor 210 in various ways that a user may recognize.

The processor 210 of a server device according to an embodiment of the present disclosure may be configured to obtain information about the device type of each of at least one device, define a plurality of security levels corresponding to at least one of the number of device detections or a device type (wherein the specific operation of each device is allowed or restricted based on each security level) and provide a user-specific policy including a plurality of security levels to a device corresponding to the user.

A processor 210 according to an embodiment of the present disclosure may include a device registration unit 211 and a policy management unit 212. A device registration unit 211 may obtain and manage information about the type/number of devices in a service region 300. A policy management unit 212 may generate/define a user-specific policy (e.g., a security level corresponding to the type/number of detected location reference devices), maintain/update/delete it and provide it to a device associated with each user. The functional units of a processor 210 as above are just an example of the present disclosure, and may not necessarily include all functional units, and some functional units may be excluded or an additional functional unit may be included, and a plurality of functional units may be integrated or one functional unit may be configured by being separated into detailed functional units.

FIG. 4 is a drawing for describing an example of a device operation according to the present disclosure.

A device operation according to an example of the present disclosure may include a method for security control based on the relative location of a first device.

In S410, a first device may detect at least one second device.

For example, a first device may detect a predetermined wireless communication signal from each of at least one second device to detect a corresponding second devices. For example, a predetermined wireless communication signal may include at least one of a Bluetooth signal, a Wi-Fi signal or a Near Field Communication (NFC) signal.

In S420, a first device may determine the security level of a first device based on at least one of the number of device detections or the device type of at least one second device.

For example, a device type may include at least one of a necessary location reference device or a related location reference device. For example, a necessary location reference device may include a fixed device and an administrator device, and a related location reference device may include a general user device.

For example, a security level may be determined based on a user-specific policy provided from a server. For example, a user-specific policy may include a plurality of security levels that are predefined in response to at least one of the number of device detections or a device type. For example, a user-specific policy may be applied to a user registered for a first device, and all security-related operations of a first device may be restricted for a user other than a user registered for a first device.

In S430, a first device may include allowing or restricting the specific operation of a first device based on a security level.

For example, when a first device is accessing a security system (e.g., in an online state) and at least one necessary location reference device is detected, a security level may be applied based on the number of related location reference device detections. For example, when at least a predetermined number of related location reference devices are detected, a security level that allows all security-related operations of a first device may be applied. Alternatively, when less than a predetermined number of related location reference devices are detected, a security level that restricts at least one partial operation of a first device may be applied.

For example, when a first device is accessing a security system (e.g., in an online state) and a necessary location reference device is not detected, all security-related operations of a first device may be restricted regardless of whether a related location reference device is detected.

For example, when a first device is not accessing a security system (e.g., in an offline state) and at least one necessary location reference device is detected, a security level may be applied based on the number of related location reference device detections. For example, when at least a predetermined number of related location reference devices are detected, a security level that restricts only the specific operation of a first device may be applied. Alternatively, when less than a predetermined number of related location reference devices are detected, a security level that restricts the specific operation of a first device and at least one additional partial operation may be applied.

For example, when a first device is not accessing a security system (e.g., in an offline state), a necessary location reference device is not detected and taking out a first device is allowed (e.g., for a business trip or an outside duty), a security level may be applied based on the number of related location reference device detections. For example, when at least a predetermined number of related location reference devices are detected, a security level that allows all security-related operations of a first device may be applied. Alternatively, when less than a predetermined number of related location reference devices are detected, a security level that restricts at least one partial operation of a first device may be applied.

For example, when a first device is not accessing a security system (e.g., in an offline state), a necessary location reference device is not detected and taking out a first device is not allowed (e.g., for an arbitrary breakaway from a service region 300), all security-related operations of a first device may be restricted regardless of whether a related location reference device is detected.

Additionally or alternatively, a necessary location reference device may include a higher necessary location reference device (e.g., an executive device) and a lower necessary reference device (e.g., a team leader device). For example, more operations of a first device may be restricted when a lower necessary location reference device is detected compared to when a higher necessary location reference device is detected. Alternatively, a policy/security level may be defined as an equal necessary location reference device without distinguishing between a higher necessary location reference device and a lower necessary location reference device.

Additionally or alternatively, when a necessary location reference device is not detected for a predetermined period of time, access to at least one of specific data or an asset management agent (e.g., a DRM agent, a DLP agent, etc.) stored in a first device may be restricted.

Additionally or alternatively, a first device may re-verify whether at least one second device is detected, re-determine the security level of a first device based on at least one of the number of device detections or the device type of at least one re-verified device, and allow or restrict the specific operation of a first device based on a re-determined security level.

FIG. 5 is a drawing for describing an example of a server operation according to the present disclosure.

A server operation according to an example of the present disclosure may include a method for supporting security control based on the relative location of a device by a server.

In S510, a server may obtain information on the device type of each of at least one device. Accordingly, a server may also obtain information on the number of devices for each device type.

In S520, a server may define a plurality of security levels corresponding to at least one of the number of device detections or a device type. Defining a security level may include defining the upper limit/lower limit/range of a device type and/or the number of device detections required for each security level and generating/maintaining information thereon. Based on each security level, a specific operation may be allowed or restricted in each device.

In S530, a server may provide a user-specific policy including a plurality of security levels to a device corresponding to a corresponding user.

In the example of FIG. 5, a specific characteristic for a device type, a security level and a user-specific policy is the same as described in the example of FIG. 4, so an overlapping description is omitted.

Hereinafter, specific examples of a method for security control based on the relative location of a device according to the present disclosure are described.

### Embodiment 1

FIG. 6 is a drawing for describing an example of secondary authentication according to the present disclosure.

The example of FIG. 6 shows a simple secondary authentication method based on whether a location reference device is detected.

A successful user login in S610 proceeds to S620, and otherwise, the use of a corresponding device may be completely restricted in S635. As described above, for a user who is not associated with/registered for a specific device, all operations of a device and/or all operations of an application may be blocked/restricted. In other words, a user is allowed only for specific device(s) associated/registered in advance, which is performed through user authentication such as user verification/login, etc. (hereinafter, primary authentication).

In addition to primary authentication, in the present disclosure, secondary authentication based on the type of a neighboring/detected location reference device (i.e., security level authentication) may be applied. In S620, a device may determine whether a necessary location reference device is detected. A necessary location reference device may be determined to be detected in S620 when at least one is detected (Y), and may be determined not to be detected in S620 when none are detected (N). In other words, S620 may be performed regardless of the number of device detections of a necessary location reference device. When a necessary location reference device is detected (Y), the use of a device may be allowed in S630, and otherwise (N), the use of a device may be completely restricted in S635.

FIG. 7 is a drawing for describing another example of secondary authentication according to the present disclosure.

The example of FIG. 7 shows a secondary authentication method based on whether a location reference device is detected and the number of detections.

S710 and S720 are the same as S610 and S620 in the example of FIG. 6. When a necessary location reference device is detected in S720, whether at least N related location reference devices are detected may be determined in S730. N may be defined or configured in advance by a server based on the total number of devices in a service region or a group to which a user belongs, density, a required security level, etc. When at least N related location reference devices are detected, the use of a device may be allowed in S740, and otherwise, whether less than N related location reference devices are detected or whether any related location reference device is not detected at all may be determined in S732. When less than N related location reference devices are detected, the use of a device may be partially restricted (or partially allowed) in S742, and otherwise, the use of a device may be completely restricted in S744. In this way, in the example of FIG. 7, more precise security control is possible compared to the example of FIG. 6.

As in the examples of FIGS. 6 and 7, in the present disclosure, for additional security level authentication (i.e., secondary authentication) to user authentication (i.e., primary authentication), a user's additional action (e.g., an one time password (OTP), biometric authentication information (e.g., a fingerprint, etc.)) is not required. In other words, even when a user does not recognize or perform an input/output action, a security level appropriate for a corresponding user/device may be automatically authenticated and applied based on whether to detect and/or the number of location reference devices around a device.

In addition, in the examples of FIGS. 6 and 7, a region where the use of a device and/or application service is allowed may be restricted to a region where a (necessary) location reference device is detected.

As in an example described above, a necessary location reference device is required to be detected for using a device at least for a device in an online state. In other words, when a necessary location reference device is not detected, secondary authentication itself for security level authentication may not be possible. Furthermore, a necessary location reference device may not distinguish between its type or tier, but as in examples described below, it may distinguish between a higher necessary location reference device (e.g., a device registered for/associated with a high-level manager (e.g., an executive)) and a lower necessary location reference device (e.g., a device registered for/associated with a low-level manager (e.g., a team leader)) to apply a security level differently. For example, when a higher necessary location reference device is detected, higher usability (i.e., a lower security level) may be applied, and when a higher necessary location reference device is not detected and a lower necessary location reference device is detected, lower usability (i.e., a higher security level) may be applied. When any one of higher and lower necessary location reference devices are not detected, secondary authentication for security level authentication may not be possible. When a necessary location reference device is not detected, secondary authentication may not be possible even when multiple neighboring related location reference devices are detected.

### Embodiment 2

This embodiment relates to a method for security control based on a relative location in an online state (e.g., an in-house location).

In examples described below, a specific device operation/authority allowed/restricted for each security level is just an example, and a specific operation/authority allowed/restricted at a different security level may overlap partially or may be independent, and an operation/authority allowed/restricted at any one security level may include all of the operations/authorities allowed/restricted at another security level.

FIG. 8 is a drawing showing an example of a security control operation in an online state according to the present disclosure.

In S810, whether a user device is in an online state may be determined. For example, an online state may correspond to a state in which a security system is being accessed or a state in which security according to the company's policy may be applied and controlled for a user device. For example, an online state may correspond to a case in which user authentication (or primary authentication) is possible through direct access to an in-house network (i.e., not via an external network), and it is assumed that a user is verified by successful user authentication (or primary authentication). When it is not in an online state, the use of a device may be completely restricted in S850 (i.e., it corresponds to a case in which security authentication or secondary authentication itself is not possible, and all authorities/operations of a device may be restricted).

When it is in an online state, whether a higher necessary location reference device is detected may be determined in S820. Whether it corresponds to a higher necessary location reference device may be determined based on the identification information of a device (e.g., whether it corresponds to location reference device A, B or C). When (even) a higher necessary location reference device is detected, whether at least N related location reference devices are detected may be determined in S830. When a higher necessary location reference device is detected and at least N related location reference devices are detected, a first security level (e.g., all authorities/operations of a user device are allowed) may be applied in S840. When a higher necessary location reference device is detected, but less than N and at least K related location reference devices are detected in S832, a second security level (e.g., an external device access port such as a USB port, etc. is blocked and other operations/authorities are allowed) may be applied in S842. When a higher necessary location reference device is detected, but less than K or no related location reference devices are detected in S832, a third security level (e.g., network access is blocked (additionally compared to a second security level) and other operations/authorities are allowed) may be applied in S844.

Whether a lower necessary location reference device is detected may be determined in S822. Whether it corresponds to a lower necessary location reference device may be determined based on the identification information of a device (e.g., whether it corresponds to location reference device D). When a higher necessary location reference is not detected and a lower necessary location reference device is not detected as well, a third security level (e.g., network access is blocked (additionally compared to a second security level) and other operations/authorities are allowed) may be applied in S844.

When (even) a lower necessary location reference device is detected in S822, whether at least N related location reference devices are detected may be determined in S834. When a lower necessary location reference device is detected and at least N related location reference devices are detected, a fourth security level (e.g., only all printing operations are allowed and other operations/authorities are restricted) may be applied in S846. When a lower necessary location reference device is detected, but less than N and at least K related location reference devices are detected in S836, a fifth security level (e.g., only a watermark printing operation is allowed and other operations/authorities are restricted) may be applied in S848. When a lower necessary location reference device is detected, but less than K or no related location reference devices are detected in S836, the use of a device may be completely restricted in S850 (i.e., it corresponds to a failure in security authentication or secondary authentication, and all authorities/operations of a device are restricted).

In examples described above, a specific device operation/authority allowed/restricted for each security level is just an example, and a specific operation/authority allowed/restricted at a different security level may overlap partially or may be independent, and an operation/authority allowed/restricted at any one security level may include all of the operations/authorities allowed/restricted at another security level.

### Embodiment 3

This embodiment relates to a method for security control based on a relative location in an offline state (e.g., an off-site location).

FIG. 9 is a drawing showing an example of a security control operation in an offline state according to the present disclosure.

In S910, it is assumed that a user device is determined to be in an offline state. For example, an offline state may correspond to a state in which a security system is not being accessed or a state in which security according to the company's policy may not be applied and controlled for a user device (i.e., a state in which security removal is not possible). For example, an offline state may correspond to a case in which user authentication (or primary authentication) is possible through indirect access to an in-house network (i.e., via an external network), and it is assumed that a user is verified by successful user authentication (or primary authentication). In the example of FIG. 7, if it is not in an online state, i.e., if it is in an offline state, the use of a device is completely restricted directly without additional security authentication even when user authentication is successful, whereas in FIG. 8, an example is described in which even if it is in an offline state, security authentication (or secondary authentication) is performed according to a specific condition (e.g., a business trip, an outside duty, accompanying a manager, arbitrary export) and a device operation/authority for each security level is allowed/restricted.

When it is in an offline state, whether a higher necessary location reference device is detected may be determined in S920. Whether it corresponds to a higher necessary location reference device may be determined based on the identification information of a device (e.g., whether it corresponds to location reference device E). When (even) a higher necessary location reference device is detected, whether at least N related location reference devices are detected may be determined in S930. When a higher necessary location reference device is detected and at least N related location reference devices are detected, a first offline security level (e.g., an external access port restriction) may be applied in S940. An offline security level in FIG. 8 may be defined/configured independently from a (online) security level in FIG. 7. When a higher necessary location reference device is detected, but less than N related location reference devices are detected in S932, a second offline security level (e.g., an external access port and network access restriction) may be applied in S942. When a higher necessary location reference device is detected, but no related location reference device is detected at all in S932, a third offline security level (e.g., an external access port, network access and printing restriction) may be applied in S944.

Whether a lower necessary location reference device is detected may be determined in S922. Whether it corresponds to a lower necessary location reference device may be determined based on the identification information of a device (e.g., whether it corresponds to location reference device F). When a higher necessary location reference is not detected, but a lower necessary location reference device is detected, a third offline security level may be applied regardless of whether a related location reference device is detected.

When neither a higher necessary location reference nor a lower necessary location reference is detected, whether device export is registered (or reported) may be determined in S924. For example, even in a situation where users of a low level go on a business trip/outside duty without accompanying a user of a manager level (i.e., a situation where a higher/lower necessary location reference device is not detected), considering a case where security authentication and security level application are required, in the example of FIG. 7, security authentication fails when a necessary location reference device is not detected in an online state, whereas in the example of FIG. 8, an allowance/restriction operation for each security level and security authentication may be defined even when a necessary location reference device is not detected in an offline state.

For example, when a higher/lower necessary location reference device is not detected, but device export is registered/reported, whether at least N related location reference devices are detected may be determined in S934. When device export is registered/reported and at least N related location reference devices are detected, a fourth offline security level (e.g., all authorities/operations of a user device are allowed) may be applied in S946. When device export is registered/reported and less than N and at least K related location reference devices are detected in S936, a fifth offline security level (e.g., an external access port and network access restriction) may be applied in S948. When device export is registered/reported, but less than K or no related location reference devices are detected in S936, the use of a device may be completely restricted in S950 (i.e., it corresponds to a failure in security authentication or secondary authentication and all authorities/operations of a device are restricted).

Additionally or alternatively, as shown by dotted lines in FIG. 8, in the example of FIG. 8, when a higher/lower necessary location reference device is not detected at all or when a specific (or pre-registered/reported) necessary location reference device is detected even when a necessary location reference device is detected, the use of a device may be completely restricted in S950.

As in examples described above, in an offline state, when a necessary location reference device is not detected, or device export is not registered/reported, or at least a predetermined number of related location reference devices are not detected even when device export is registered/reported, it may be determined as arbitrary export, so the use of a device may be completely restricted.

### Embodiment 4

This embodiment relates to a method for applying security control in a situation for the theft or loss of a device based on the relative location of a device.

In examples described above, a security level may be subdivided based on whether a necessary location reference device is detected in an online or offline state and/or the number of related location reference device detections, and security control such as forced termination of a device, the control of access to important/encrypted data, etc. may be applied for each security level. In an environment where stricter security control is required (e.g., an environment where it is accessible to a national secret or defense industry-related information), a leakage prevention method such as complete destruction of important data in response to the theft or loss of a device is required. Along with a method for security control based on a relative location according to the present disclosure, for example, an asset management solution such as DRM/DLP, etc., a HDD encryption solution, a bitlocker, etc. may be applied.

FIG. 10 is a drawing for describing an example in which an asset management solution is applied together with a relative location-based security control method according to the present disclosure.

The example of FIG. 10 may be applied both in online and offline states (or regardless of an online or offline state). When a login to an asset management agent (e.g., a DRM agent) is successful in S1010, access to specific data (e.g., an important asset such as security data, etc.) may be allowed in S1035. When a login to an asset management agent fails, whether a necessary location reference device is detected during a predetermined time period (e.g., X time) may be determined in S1020. When a necessary location reference device is detected during a predetermined time period, it may return to S1010 to determine whether to log in to an asset management agent. When a necessary location reference device is not detected during a predetermined time period, strict security control including deleting specific data stored in a device (e.g., an important asset such as security data, etc.) and deleting an asset management agent may be applied in S1030.

FIG. 11 is a drawing for describing another example in which an asset management solution is applied together with a relative location-based security control method according to the present disclosure.

In S1110 of FIG. 11, whether it is in an offline state may be determined. When it is not in an offline state, i.e., when it is in an online state, whether to log in to an asset management agent (e.g., a DRM agent) may be determined in S1120. When a login to an asset management agent is successful, access to specific data (e.g., an important asset such as security data, etc.)

may be allowed in S1145. When a login to an asset management agent fails, whether a necessary location reference device is detected during a predetermined time period (e.g., X time) may be determined in S1130. When a necessary location reference device is detected during a predetermined time period, it may return to S1120 to determine whether to log in to an asset management agent. When a necessary location reference device is not detected during a predetermined time period, strict security control including deleting specific data stored in a device (e.g., an important asset such as security data, etc.) and deleting an asset management agent may be applied in S1140.

When it is determined to be in an offline state in S1110, whether a necessary location reference device is detected during a predetermined time period (e.g., X time) may be determined in S1130. When a necessary location reference device is detected during a predetermined time period, whether to log in to an asset management agent may be determined in S1120. When a necessary location reference device is not detected during a predetermined time period, strict security control including deleting specific data stored in a device (e.g., an important asset such as security data, etc.) and deleting an asset management agent may be applied in S1150. In other words, in an offline state, regardless of whether to log in to an asset management agent, when a necessary location reference device is not detected for a predetermined time period, strict security control including deleting an important asset and deleting an asset management agent may be applied.

### Embodiment 5

This embodiment relates to a method for detecting a change in the relative position of a device and applying security control based thereon.

As described above, after the user of a device completes user authentication (or primary authentication) and security authentication (or secondary authentication) (i.e., after obtaining the authority to use a device (or access a document) according to a predetermined security level based on the number of detections of and/or whether to detect neighboring necessary/related location reference devices), the movement of a device (i.e., a location change) may occur. For example, a user device may move or a neighboring location reference device may move. In this case, when the relative location of a user device verified based on the detection of a neighboring location reference device is changed, security control may be additionally applied based on a changed location.

Such location change detection and determination/application of a user-specific policy/security level accordingly may be performed periodically or a user-specific policy/security level may be determined and applied again based on an event (e.g., when it is changed from an online state to an offline state or when the number of detections of/whether to detect location reference devices is changed compared to before, etc.). In other words, whether a neighboring location reference device is detected may be re-verified, a security level may be re-determined based on a re-verified device type and/or the number of device detections, and the specific operation of a device may be allowed/restricted based on a re-determined security level.

Accordingly, the movement of a device may be detected after a user's security authentication is completed, and a device may be delivered to a third party other than a corresponding user to prevent data leakage and handle a situation where it is changed to an offline state or taken out, so security control may be strengthened.

Although the exemplary methods of this disclosure are represented by a series of steps for clarity of explanation, they are not intended to limit the order in which the steps are performed, and if necessary, each step may be performed simultaneously or in a different order. In order to implement the method according to the present disclosure, other steps may be included to the illustrative steps additionally, exclude some steps and include remaining steps, or exclude some steps and include additional steps.

The various embodiments of the disclosure are not intended to be exhaustive of all possible combination, but rather to illustrate representative aspects of the disclosure, and the features described in the various embodiments may be applied independently or in a combination of two or more.

In addition, various embodiments of the present disclosure may be implemented by hardware, firmware, software, or a combination thereof. A case of hardware implementation may be performed by one or more application specific integrated circuits (ASICs), digital signal processors (DSPs), digital signal processing devices (DSPDs), programmable logic devices (PLDs), field programmable gate arrays (FPGAs), a general processor, a controller, a microcontroller, a microprocessor, or the like.

The scope of the present disclosure is to encompass software or machine-executable instructions (e.g., operating system, applications, firmware, instructions, or the like) by which operations according to method of various embodiments are executed on a device or a computer, and non-transitory computer-readable media executable on the device or the computer, on which such software or instructions are stored.

What is claimed is:

1. A method for a security control based on a relative location of a first device, the method comprising:
detecting at least one second device;
based on at least one of a device type or a number of device detections of the at least one second device, determining a security level of the first device; and
allowing or restricting a specific operation of the first device based on the security level,
wherein the device type includes at least one of a necessary location reference device or a related location reference device.

2. The method of claim 1, wherein:
when the first device is being accessed to a security system, and at least one necessary location reference device is detected:
when at least a predetermined number of related location reference devices are detected, a security level in which all security-related operations of the first device are allowed is applied,
when less than the predetermined number of related location reference devices are detected, a security level in which at least one partial operation of the first device is restricted is applied.

3. The method of claim 1, wherein:
when the first device is being accessed to a security system, and the necessary location reference device is not detected:
all security-related operations of the first device are restricted regardless of whether the related location reference device is detected.

4. The method of claim 1, wherein:
when the first device is not being accessed to a security system, and at least one necessary location reference device is detected:
when at least a predetermined number of related location reference devices are detected, a security level in which only the specific operation of the first device is restricted is applied,
when less than the predetermined number of related location reference devices are detected, a security level in which at least one additional partial operation and the specific operation of the first device are restricted is applied.

5. The method of claim 1, wherein:
when the first device is not being accessed to a security system, the necessary location reference device is not detected, and an export for the first device is allowed:
when at least a predetermined number of related location reference devices are detected, a security level in which all security-related operations of the first device are allowed is applied,
when less than the predetermined number of related location reference devices are detected, a security level in which at least one partial operation of the first device is restricted is applied.

6. The method of claim 1, wherein:
when the first device is not being accessed to a security system, the necessary location reference device is not detected, and an export for the first device is not allowed,
all security-related operations of the first device are restricted regardless of whether the related location reference device is detected.

7. The method of claim 2, wherein:
the necessary location reference device includes a higher necessary location reference device and a lower necessary location reference device,
compared to a case in which the higher necessary location reference device is detected, when the lower necessary location reference device is detected, more operations of the first device are restricted.

8. The method of claim 1, wherein:
the security level is determined based on a user-specific policy provided from a server.

9. The method of claim 8, wherein:
the user-specific policy includes a plurality of predefined security levels in response to the at least one of the device type or the number of device detections.

10. The method of claim 8, wherein:
the user-specific policy is applied to a user registered for the first device,
all security-related operations of the first device are restricted for a user other than the user registered for the first device.

11. The method of claim 1, wherein:
when the necessary location reference device is not detected during a predetermined time, an access to at least one of specific data or an asset management agent stored in the first device is restricted.

12. The method of claim 1, wherein the method further includes:
re-verifying whether the at least one second device is detected;
based on at least one of a device type or a number of device detections of the at least one re-verified second device, re-determining the security level of the first device; and
allowing or restricting the specific operation of the first device based on the re-determined security level.

13. The method of claim 1, wherein:
the detection includes detecting a predetermined wireless communication signal from each of the at least one second device.

14. The method of claim 13, wherein:
the predetermined wireless communication signal includes at least one of a Bluetooth signal, a Wi-Fi signal, or a near field communication (NFC) signal.

15. The method of claim 1, wherein:
the necessary location reference device includes a fixed device and an administrator device,
the related location reference device includes a general user device.

16. A first device performing a security control based on a relative location, the first device comprising:
a transceiver;
a memory;
a user interface; and
a processor,
wherein the processor is configured to:
detect at least one second device;
based on at least one of a device type or a number of device detections of the at least one second device, determine a security level of the first device; and
allow or restrict a specific operation of the first device based on the security level,
wherein the device type includes at least one of a necessary location reference device or a related location reference device.

17. A method for supporting a security control based on a relative location of a device by
a server, the method comprising:
obtaining information about a device type of each of at least one device;
defining a plurality of security levels corresponding to at least one of the device type or a number of device detections, wherein a specific operation of each device is allowed or restricted based on each security level; and
providing a user-specific policy including the plurality of security levels to a device corresponding to a user,
wherein the device type includes at least one of a necessary location reference device or a related location reference device.
